(19) United States
(12) Patent Application Publication
(10) Pub. No.: US 2011/0047165 A1
(43) Pub. Date: Feb. 24, 2011

(54) Network cache, a user device, a computer program product and a method for managing files

(76) Inventors: Ofer Wald, Petech Tikva (IL); Ayelet Wald, Petach Tikva (IL)

Correspondence Address: RECHES PATENTS, 211 North Union St., Suite 100, Alexandria, VA, 22314, US

(21) Appl. No.: 12/374,315

(22) PCT Filed: Jul. 16, 2007
(86) PCT No.: PCT/IL07/00891

§ 371 Date: Apr. 21, 2010

Related U.S. Application Data
(60) Provisional application No. 60/807,935, filed on Jul. 21, 2006.

(51) Int. Cl. G06F 17/30; G06F 15/167; G06F 15/16

(52) U.S. Cl. 707/747; 709/213; 709/219; 707/E17.083; 707/E17.032

(57) ABSTRACT

A network cache (30) that includes multiple storage units (20) and multiple control units (10) that are coupled to multiple user devices (50) via a network (40), wherein the network cache is adpated to receive a file related request provided from a user device, and wherein the network cache is adapted to respond to the file related request by a selected control unit and by a selected storage unit, wherein the selected storage unit is selected in response to a file related request based on a file tag that is responsive to a content of the file, and wherein the selected control unit is selected in response to an identity of the user device.

### RELATED APPLICATIONS

This patent application claims priority from U.S. provisional patent Ser. No. 60/807,935 filed Jul. 21 2007.

### FIELD OF THE INVENTION

The invention relates to methods, network caches, user devices and computer program products for managing files.

### BACKGROUND OF THE INVENTION

The amount of information has dramatically increased during the last decade. Text and media files are being generated by more and more users and are shared between even larger groups of users. Growing amounts of files are being exchanged, by utilizing peer to peer technologies (as well as other distribution technologies), over networks and are being stored in various storage systems.

Storage systems are required to dynamically grow as well as adapt to different environments.

There is a growing need to provide a scalable storage system.

### SUMMARY

A network cache, comprising: multiple storage units and multiple control units that are coupled to multiple users devices via a network; wherein the network cache is adapted to receive a file related request provided from a user device; and wherein the network cache is adapted to respond to the file related request by a selected control unit and by a selected storage unit; wherein the selected storage unit is selected in response to a file related request based on a file tag that is responsive to a content of the file; and wherein the selected control unit is selected in response to an identity of the user device.

A method for managing files, the method includes: receiving a file related request provided from a user device, at a network cache that comprises multiple storage units and multiple control units that are coupled to multiple users devices via a network; responding to the file related request by a selected control unit and by a selected storage unit; wherein the selected control unit is selected in response to an identity of the user device and the selected storage unit is selected in response to a file tag that is responsive to a content of the file.

A computer program product comprising a computer usable medium including a computer readable program, wherein the computer readable program when executed on a computer causes the computer to: receive a file related request provided from a user device, at a network cache that comprises multiple storage units and multiple control units that are coupled to multiple users devices via a network; and respond to the file related request by a selected control unit and by a selected storage unit; wherein the selected control unit is selected in response to an identity of the user device and the selected storage unit is selected in response to a file tag that is responsive to a content of the file.

A computer program product comprising a computer usable medium including a computer readable program, wherein the computer readable program when executed on a computer causes the computer to: generate a file tag responsive to a content of a file to be associated with a file related request; send to a network cache a file related request that comprises the file tag; and assist in a display of virtual directory of files that were requested to be stored at the network cache by a user of the computer.

A device, the device includes: a processor, adapted to generate a file tag responsive to a content of a file to be associated with a file related request; and assist in a display of virtual directory of files that were requested to be stored at the network cache by a user of the computer; and a communication module adapted to send to a network cache a file related request that comprises the file tag.

A method, including: generating a file tag responsive to a content of a file to be associated with a file related request; and sending to a network cache a file related request that comprises the file tag.

### BRIEF DESCRIPTION OF THE DRAWINGS

The abovementioned and other objects, features, and advantages of the present invention will become more apparent from the following detailed description, when applied in conjunction with the accompanying drawings. In the drawings, similar reference characters denote similar elements throughout the different views, in which:

FIG. 1 illustrates a network cache and its environment, according to an embodiment of the invention;

FIG. 2 illustrates a network cache and its environment, according to another embodiment of the invention;

FIG. 3 illustrates a control unit, according to an embodiment of the invention;

FIG. 4 illustrates a storage unit, according to an embodiment of the invention;

FIG. 5 illustrates some software components installed on a user device, according to an embodiment of the invention;

FIG. 6 is a flow chart of a method for managing files, according to an embodiment of the invention; and

FIG. 7 is a flow chart of a method for managing files, according to an embodiment of the invention.

### DETAILED DESCRIPTION OF THE DRAWINGS

A network cache is designed in a scalable manner. The network cache includes multiple storage units and multiple control units. Control units are allocated per user devices while storage units are allocated per file tags that are responsive to the content of the files. This scalable approach enables to easily adapt the network cache to different scenarios that are characterized by many user devices, few user devices, many files, few files and the like.

Conveniently, a single copy of each file is stored at the network cache. If multiple users request to store the file at the network cache then metadata that reflects the location of that file is stored at each control unit that is associated with each of these multiple users.

The allocation of user devices per control unit and the allocation of file tag values per storage unit can be dynamically changed. The load on the various control unit and on the various storage units can be measured. Once measured the load distribution can enable to alter to allocation of user (per control unit) and files (per storage unit).

Conveniently, a client hosted on a user device can communicate with the network cache. The client can assist in displaying a virtual folder that represents the network cache to the user.

In order to increase the security of the network cache and especially to prevent a user from accessing files of another user, the network cache generates a file related request tag that once received by a storage unit of the network cache can assist in determining how to respond to the file related request.

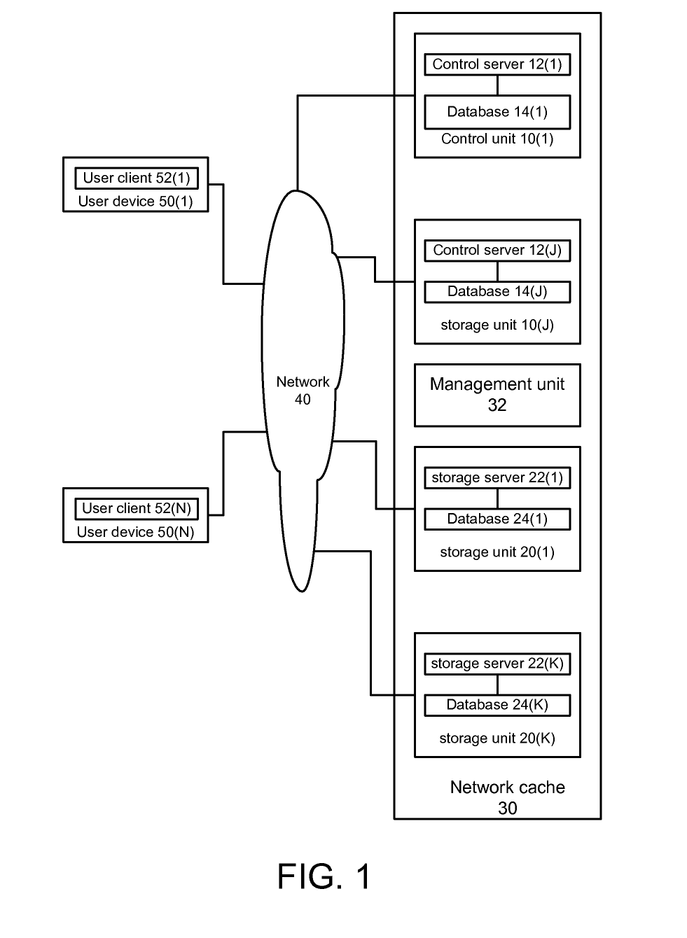

FIG. 1 illustrates network cache 30 and its environment, according to an embodiment of the invention.

Network cache 30 includes multiple control units 10(1)-10(J) and multiple storage units 20(1)-20(K). K and J are positive integers. K and J can differ from each other, but this is not necessarily so.

Network cache 30 is connected to multiple user devices 50(1)-50(N) via network 40. N is a positive integer. Network 40 can include one or more networks of any type of network such as the Internet, a local area network (LAN), a wide area network (WAN), and the like.

The various storage and control units of network cache 30 can be connected to each other, can be located in one or more locations and the like.

Conveniently, network cache 30 includes management unit 32. Management unit 32 determines the allocation of user devices per control unit and the allocation of storage unit per file tag value. It is noted that the management unit 32 can be included in one or more of the other units (storage and/or control) of network cache 30. Management unit 32 can dynamically alter the mapping between file tag values and storage units for various reasons including, but not limited to, a change in a number of storage units, a change in a number of files, and load balancing characteristics.

A sample control unit 10(j) (wherein j ranges between 1 and J) includes a control server 12(j) and database 14(j). Control server 12(j) can be located in proximity to database 14(j) but this is not necessarily so. Control server 12(j) can be connected to database 14(j) via one or more links, via one or more networks, and the like. Database 14(j) can store, for each user device associated with control unit 10(j), a user device file directory metadata.

A sample storage unit 20(k) (wherein k ranges between 2 and K) includes a storage server 22(k) and database 24(k). The storage server 22(k) can be located in proximity to database 24(k) but this is not necessarily so. Storage server 22(k) can be connected to database 24(k) via one or more links, via one or more networks, and the like.

Conveniently, when a file related request (such as but not limited to a request to store a file at the network cache, a request to retrieve a file from the network cache, a request to delete a file from the network cache) is received by network cache 30 the network cache can respond to the request by using selected control unit and by a selected storage unit. The selection of the responding control and storage units of the network cache is responsive to the mentioned above allocation. Accordingly, a selected storage unit is selected in response to a file tag that in turn is responsive to a content of the file associated with the file related request. The selected control unit is selected in response to an identity of the user device.

Typically, the file related request is first managed by one or more control units and just afterwards is managed by the selected storage unit. Typically, a user device (such as user device 50(n), wherein n ranges between 1 and N) is connected to a certain control unit that is not necessarily the selected control unit. This can result from network constraints, network policy, user device constraints and the like.

If the certain control unit differs from the selected control unit that the file related request is re-directed to the selected control unit. The re-direction can be executed solely by network cache 32 but this is not necessarily so.

According to an embodiment of the invention, user device 50(n) can also participate in the re-direction process. The certain control unit can send to user device 50(n) a response indicative of the selected control unit. User device 50(n) can then send the file related request to the selected control unit.

If, for example, the file related request is a request to store the file in network cache 30 then the selected control unit can check if the file is already stored in network cache 30. If the answer is positive then the file itself is not fetched but a user device file directory metadata is updated.

If, for example the file related request is a request to delete a file from network cache 30 then the file is not necessarily deleted. Rather, a user device file directory metadata is updated to reflect a virtual deletion of the file from the user device file directory. It is noted that a file can be deleted according to a file deletion policy. The file deletion policy can be responsive to lack of interest in the file.

According to an embodiment of the invention the selected control unit is further adapted to generate a file related request tag. The file related request tag can be generated in response to the content of the file, in response to a timing of the reception of the file related request by the network cache (or other equivalent point in time such as the time of generation of the request by the user device) and optionally in response to the size of the file. The file related request tag will be sent to the user device. The user device sends a file related request tag to the selected storage unit that may determine (based upon the file related request tag) whether to reject the file related request.

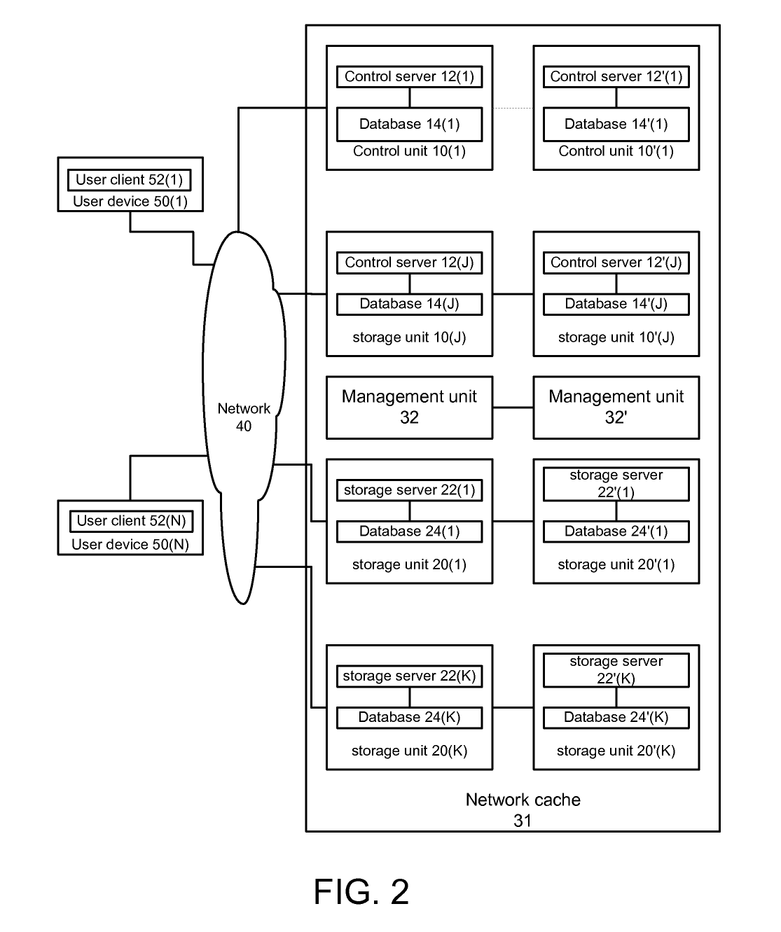

FIG. 2 illustrates network cache 31 and its environment, according to another embodiment of the invention.

Network cache 31 differs from network cache 30 by further including backup control units 10′(1)-10′(J), backup storage units storage units 20′(1)-20′(K) and backup management unit 32′ that can backup the corresponding control units 10(1)-10(J), storage units 20(1)-20(K) and management unit 32. The backup is conveniently based upon constant updates of the backup control and storage units. Various backup technologies can be applied.

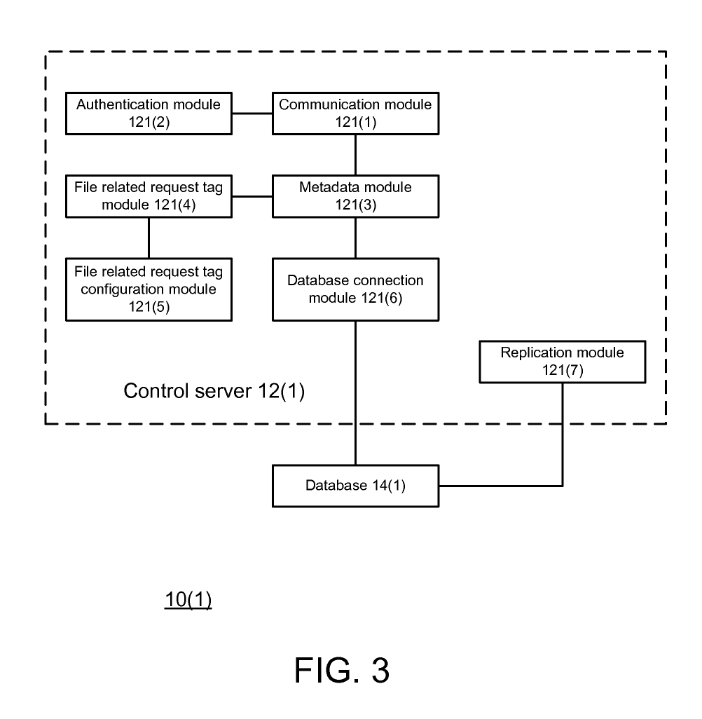

FIG. 3 illustrates control unit 10(1), according to an embodiment of the invention.

Control unit 10(1) includes database 14(1) and control server 12(1). Control server 12(1) includes: communication module 121(1), authentication module 121(2), metadata module 121(3), file related request tag module 121(4), tag configuration module 121(5), database connection module 121(6) and replication module 121(7).

Communication module 121(1) is connected to authentication module 121(2) and metadata module 121(3). Metadata module 121(3) is also connected to file related request tag module 121(4) and database connection module 121(6). Tag configuration module 121(5) is connected to file related request tag module 121(4). Database 14(1) is connected to database connection module 121(6) and to replication module 121(7).

Communication module 121(1) communicates with a corresponding communication module hosted by the user device. It can facilitate secure communication with the user device, for example by utilizing SSL based communications.

File related request tag module 121(4) generates the file related request tag. Tag configuration module 121(5) can determine how the file related request tag is generated. It can determine which information entities will be processed and how they should be processed. Replication module 121(7) controls a backup process of database 14(1) to a backup database 14′(1). Database communication module 121(6) facilitates access to database 14(1). Database 14(1) stores metadata such as but not limited to user device file directory metadata. Metadata module 121(3) acts as a mediator between meta-data stored in database 14(1) related to all versions and all users on all data machines and the client side. It converts the format of metadata stored at database 14(1) to a format that compliant with a format of a user device that sends a file related request.

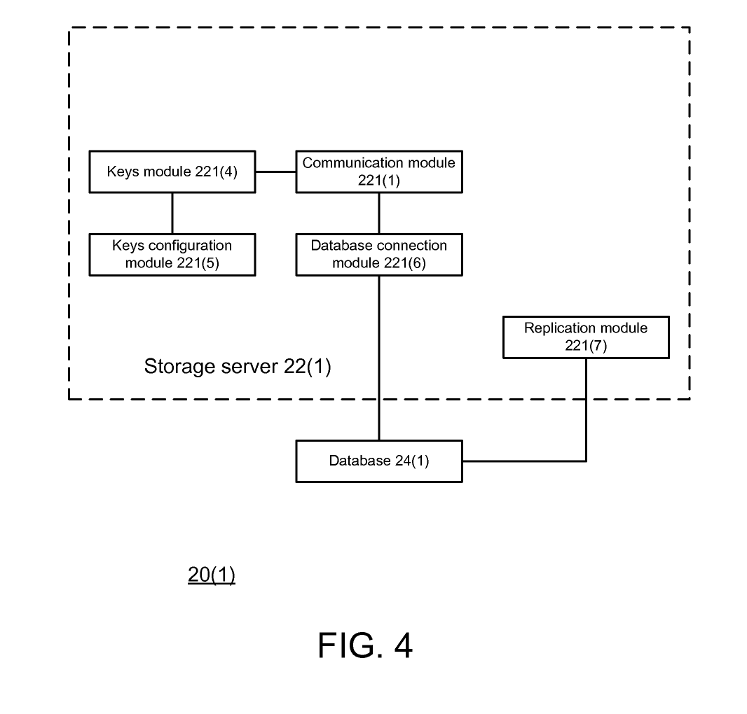

FIG. 4 illustrates storage unit 20(1), according to an embodiment of the invention.

Storage unit 20(1) includes database 24(1) and storage server 22(1). Storage server 22(1) includes: communication module 221(1), file related request tag module 221(4), tag configuration module 221(5), database connection module 221(6) and replication module 221(7).

Communication module 221(1) is connected to file related request tag module 221(4) and database connection module 221(6). Tag configuration module 221(5) is connected to file related request tag module 221(4). Database 24(1) is connected to database connection module 221(6) and to replication module 221(7).

Communication module 221(1) communicates with a corresponding communication module hosted by the user device. It can facilitate secure communication with the user device, for example by utilizing SSL based communications.

File related request tag module 221(4) receives the file related request tag, processes it to extract the data fields that formed the file related request tag and determines whether to accept or reject a file related request based upon the content of these data fields. Tag configuration module 221(5) can determine how to extract the data fields from the file related request tag. Replication module 221(7) storages a backup process of database 24(1) to a backup database 24′(1). Database communication module 221(6) facilitates access to database 24(1). Database 24(1) stores files.

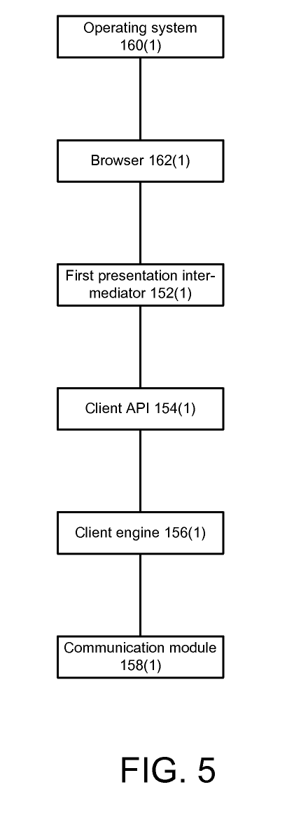

FIG. 5 illustrates some software components installed on user device 50(1), according to an embodiment of the invention.

User device 50(1) can execute code. It hosts operating system 160(1), browser 162(1) and user client 52(1). User client 52(1) includes first presentation inter-mediator 152(2), client application programming interface (API) 154(1), client engine 156(1) and communication module 158(1).

Client API 154(1) provides a simple interface that supports simple file related requests such as delete file, add file, retrieve file, and the like. First presentation inter-mediator 152(2) provides an interface between browser 162(1) (and especially the browser application program interface) and between client API 154(1). Communication module 158(1) communicates with corresponding communication modules (such as 121(1) and 221(1)) of control and storage units. It can facilitate secure communication with a control unit or with a storage unit, for example by utilizing SSL based communications.

Client engine 156(1) can perform the following operations: (i) generate a file tag responsive to a content of a file to be associated with a file related request; (ii) control a provision of the file related request to a control unit, (iii) control a provision of the file related request to a control unit, (iv) assist in a display of virtual directory of files that were requested to be stored at the network cache by a user of the computer, (v) receive user commands and translate them to file related requests.

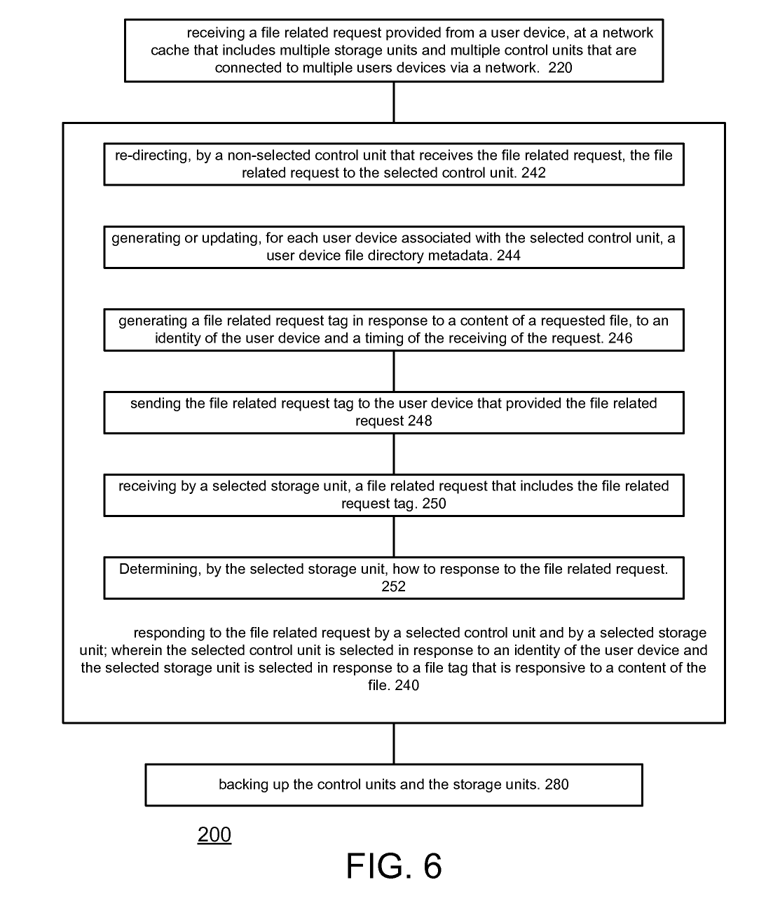

FIG. 6 is a flow chart of method 200 for managing files, according to an embodiment of the invention.

Conveniently, method 200 is executed by the network cache while method 300 is executed by a user device and especially by a client hosted by the user device.

Method 200 starts by stage 220 of receiving a file related request provided from a user device, at a network cache. The network cache includes multiple storage units and multiple control units that are connected to multiple devices of user (users devices) via a network. The file related request includes a file tag that is responsive to the content of the file. Conveniently, the file tag is generated by applying a hash function on the file. The file tag can be also responsive to the size of the file. It is noted that the file tag is conveniently generated by a user device and especially by a client hosted by the network device.

Stage 220 is followed by stage 240 of responding to the file related request by a selected control unit of the network cache and by a selected storage unit of the network cache. The selected control unit is selected in response to an identity of the user device and the selected storage unit is selected in response to a file tag that is responsive to a content of the file.

It is noted that stage 240 of responding can include at least one of the following stages: (i) re-directing, by a non-selected control unit that receives the file related request, the file related request to the selected control unit; (ii) sending to a user device a response indicative of the selected control unit, (iii) generating, for each user device associated with the selected control unit, a user device file directory metadata; (iv) updating the user device metadata such as to reflect the file related request and a response to the file related request; (v) generating a file related request tag in response to a content of a requested file, to an identity of the user device and a timing of the receiving of the request, (vi) sending the file related request tag to the user device, (vii) receiving, by a selected storage unit, a file related request that includes the file related request tag, (viii) determining, by the selected storage unit, how to respond to the file related request, (ix) storing the file at the selected storage unit, if the file related request is a request to store the file and if the network cache does not store the file, (x) updating the user device file directory to represent a virtual deletion of the file if the file related request was a request to delete the file.

For simplicity of explanation some of the mentioned above stages are illustrated by boxes. The re-directing is illustrated by box 242. The generating of a user device file directory metadata is illustrated by box 244. The stage of generating a file related request tag is illustrated by box 246. The stage of sending the file related request tag is illustrated by box 248. The stage of receiving by the selected storage unit is illustrated by box 250. The stage of determining how to respond is illustrated by box 252.

It is noted that the stage of generating a file related request tag can include applying a hash function. It is noted that the file related request tag can also be responsive to the size of the file.

Conveniently, method 200 enables to define a maximal timing gap between the generation of the file related request tag and a reception of the file related request by the selected storage unit. If the maximal timing gap is exceed the selected storage unit can eject the request.

Conveniently, method 200 also includes stage 280 of backing up the control units and the storage units.

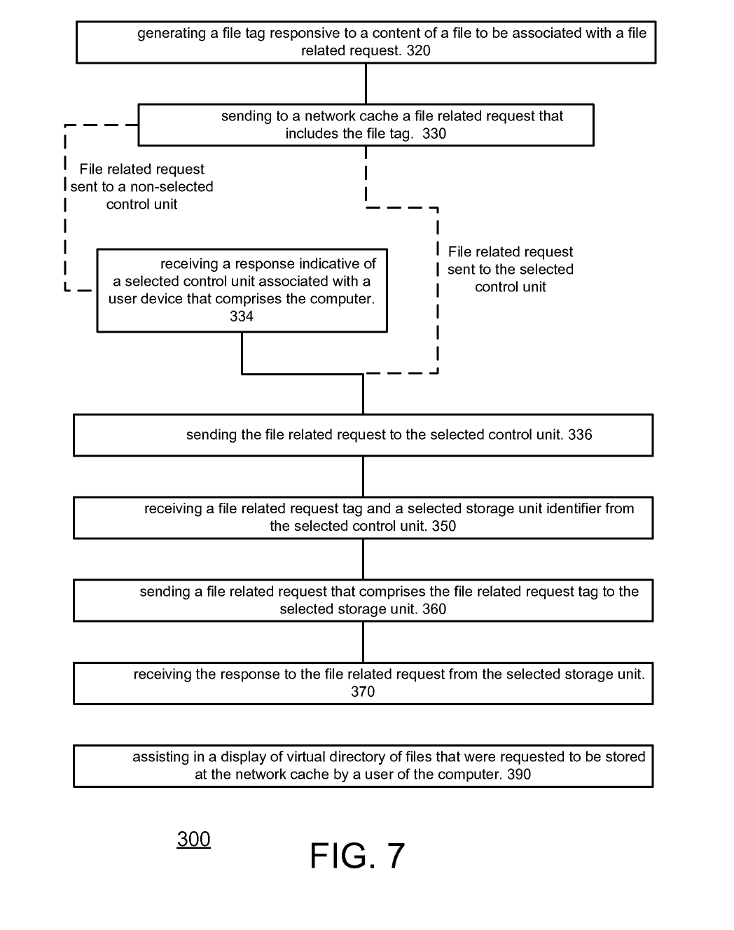

FIG. 7 is a flow chart of a method 300 for managing files, according to an embodiment of the invention.

Method 300 starts by stage 310 of generating a file tag responsive to a content of a file to be associated with a file related request.

Stage 310 is followed by stage 330 of sending to a network cache a file related request that comprises the file tag.

Conveniently, stage 310 includes generating the file tag by applying a hash function on a content of the file and on a size of the file.

Stage 330 can include sending a file related request that includes the file tag to a non-selected control unit. According to an embodiment of the invention the network cache re-directs the file related request to the selected control unit. According to another embodiment of the invention, illustrated by stage 334 method 300 includes receiving a response indicative of a selected control unit associated with a user device.

If the file related request was initially sent to the selected control unit or if the file related request is re-directed to the selected control unit without intervention of the user device then method 300 progresses to stage 336 of sending, by the user device, the file related request to the selected control unit.

Stage 336 is followed by stage 350 of receiving a file related request tag and a selected storage unit identifier from the selected control unit.

Stage 350 is followed by stage 360 of sending a file related request that includes the file related request tag to the selected storage unit.

Stage 370 is followed by stage 370 of receiving the response to the file related request from the selected storage unit.

According to an embodiment of the invention the files that are stored at the network cache are displayed as belonging to a virtual directory of the user device. Accordingly, method 300 also includes assisting in a display of virtual directory of files that were requested to be stored at the network cache by a user of the computer. The assisting can include generating commands that enable the display of the virtual directory, and the like.

Conveniently, a computer program product is provided. The computer program product including a computer usable medium including a computer readable program, wherein the computer readable program when executed on a computer causes the computer to: receive a file related request provided from a user device, at a network cache that includes multiple storage units and multiple control units that are coupled to multiple users devices via a network; and respond to the file related request by a selected control unit and by a selected storage unit; wherein the selected control unit is selected in response to an identity of the user device and the selected storage unit is selected in response to a file tag that is responsive to a content of the file.

Conveniently the computer readable program when executed on a computer causes the computer to select the selected storage unit based upon a file tag that is also responsive to a size of the file.

Conveniently the computer readable program when executed on a computer causes the computer to select the selected storage unit based upon the file tag that is received from a user device that hosts a client that generated the file tag.

Conveniently the computer readable program when executed on a computer causes the computer to re-direct, by a non-selected control unit that receives the file related request, the file related request to the selected control unit.

Conveniently the computer readable program when executed on a computer causes the computer to generate, at a selected control unit and for each user device associated with the selected control unit, a user device file directory metadata.

Conveniently the computer readable program when executed on a computer causes the computer to generate a file related request tag in response to a content of a requested file, to an identity of the user device and a timing of the receiving of the request.

Conveniently the computer readable program when executed on a computer causes the computer to receive, from the user device, a file related request that includes the file related request tag and to determine how to respond to the file related request.

Conveniently the computer readable program when executed on a computer causes the computer to generate the file related request tag in response to a size of the file.

Conveniently the computer readable program when executed on a computer causes the computer to: receive a file related request that is a request to store the file at the network cache, store the file at the selected storage unit if the file is not stored in the network cache and update metadata stored in the selected control unit.

A computer program product including a computer usable medium including a computer readable program, wherein the computer readable program when executed on a computer causes the computer to: generate a file tag responsive to a content of a file to be associated with a file related request; send to a network cache a file related request that includes the file tag; and assist in a display of virtual directory of files that were requested to be stored at the network cache by a user of the computer.

Conveniently the computer readable program when executed on a computer causes the computer to generate the file tag by applying a hash function on a content of the file and on a size of the file.

Conveniently the computer readable program when executed on a computer causes the computer to: send a file related request that includes the file tag to a control unit; receive a response indicative of a selected control unit associated with a user device that includes the computer; send the file related request to the selected control unit; receive a file related request tag and a selected storage unit identifier from the selected control unit; send a file related request that includes the file related request tag to the selected storage unit; and receive the response to the file related request from the selected storage unit.

Conveniently the computer readable program when executed on a computer causes the computer to: send a file related request to a selected control unit associated with a user device that includes the computer; receive a file related request tag and a selected storage unit identifier from the selected control unit; send a file related request that includes the file related request tag to the selected storage unit; and receiving a response to the file related request from the selected storage unit.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

We claim:

1. A network cache, comprising: multiple storage units and multiple control units that are coupled to multiple users devices via a network; wherein the network cache is adapted to receive a file related request provided from a user device; wherein the network cache is adapted to respond to the file related request by a selected control unit and by a selected storage unit; wherein the selected storage unit is selected in response to a file related request based on a file tag that is responsive to a content of the file; and wherein the selected control unit is selected in response to an identity of the user device.

2. The network cache according to claim 1 further adapted to select the selected storage unit in response to a file tag that is further responsive to a size of the file.

3. The network according to claim 1 wherein the network cache is adapted to select the selected storage unit in response to the file tag that is generated by a client that is hosted by the user device.

4. The network cache according to claim 1 wherein a non-selected control unit that receives a file related request is adapted to re-direct the file related request to the selected control unit.

5. The network cache according to claim 1 wherein each control unit stores, for each user device associated with the control unit, a user device file directory metadata.

6. The network cache according to claim 1 wherein a selected control unit is adapted to: receive a file retrieval request from a user device associated with the selected control unit, and generate a file related request tag in response to a content of a requested file, to an identity of the user device and a timing of the file retrieval request.

7. The network cache according to claim 6 wherein the selected control unit is further adapted to send the file related request tag to the user device, and wherein the selected storage unit is adapted to receive, from the user device, a file related request that comprises the file related request tag and to determine how to respond to the file related request.

8. The network cache according to claim 6 wherein the selected control unit is further adapted to generate the file related request tag in response to a size of the file.

9. The network cache according to claim 1 further comprising backup control units and backup storage units adapted replace failed control units and failed storage units.

10. The network cache according to claim 1 further adapted to alter a mapping between file tag values and storage units in response to a change in a number of storage units; and to alter a mapping between identities of user devices and control units in response to a change in a number of control units.

11. The network cache according to claim 1 wherein the selected storage unit is adapted to respond to a file related request that is a request to store the file by storing the file if the file is not already stored in the network cache and wherein the network cache is further adapted to update metadata stored in the selected control unit.

12. A method for managing files, the method comprises:
receiving a file related request provided from a user device, at a network cache that comprises multiple storage units and multiple control units that are coupled to multiple users devices via a network; and responding to the file related request by a selected control unit and by a selected storage unit; wherein the selected control unit is selected in response to an identity of the user device and the selected storage unit is selected in response to a file tag that is responsive to a content of the file.

13. The method according to claim 12 wherein the responding comprises selecting the storage unit in response to a file tag that is also responsive to a size of the file.

14. The method according to claim 12 wherein the responding comprises selecting the selected storage unit in response to a file tag that is provided from a user device that hosts a client that generated the file tag.

15. The method according to claim 12 wherein the responding comprises re-directing, by a non-selected control unit that receives the file related request, the file related request to the selected control unit.

16. The method according to claim 12 wherein the responding comprises generating, for each user device associated with the selected control unit, a user device file directory metadata.

17. The method according to claim 12 further comprising generating a file related request tag in response to a content of a requested file, to an identity of the user device and a timing of the receiving of the request.

18. The method according to claim 17 further comprising receiving by a selected storage unit, a file related request that comprises the file related request tag and determining how to response to the file related request.

19. The method according to claim 17 wherein the generating of the file related request tag is further responsive to a size of the file.

20. The method according to claim 12 further comprising backing up the control units and the storage units.

21. The method according to claim 12 wherein the file related request is a request to store the file at the network cache and wherein the stage of selecting the storage unit is followed by: storing the file at the selected storage unit if the file is not stored in the network cache, and updating metadata stored in the selected control unit.

22. A computer program product comprising a computer usable medium including a computer readable program, wherein the computer readable program when executed on a computer causes the computer to: receive a file related request provided from a user device, at a network cache that comprises multiple storage units and multiple control units that are coupled to multiple users devices via a network; and respond to the file related request by a selected control unit and by a selected storage unit; wherein the selected control unit is selected in response to an identity of the user device and the selected storage unit is selected in response to a file tag that is responsive to a content of the file.

23. The computer program product according to claim 22, wherein the computer readable program when executed on a computer causes the computer to select the selected storage unit based upon a file tag that is also responsive to a size of the file.

24. The computer program product according to claim 22, wherein the computer readable program when executed on a computer causes the computer to select the selected storage unit based upon the file tag that is received from a user device that hosts a client that generated the file tag.

25. The computer program product according to claim 22, wherein the computer readable program when executed on a computer causes the computer to re-direct, by a non-selected control unit that receives the file related request, the file related request to the selected control unit.

26. The computer program product according to claim 22, wherein the computer readable program when executed on a computer causes the computer to generate, at a selected control unit and for each user device associated with the selected control unit, a user device file directory metadata.

27. The computer program product according to claim 22, wherein the computer readable program when executed on a computer causes the computer to generate a file related request tag in response to a content of a requested file, to an identity of the user device and a timing of the receiving of the request.

28. The computer program product according to claim 27, wherein the computer readable program when executed on a computer causes the computer to receive, from the user device, a file related request that comprises the file related request tag and to determine how to respond to the file related request.

29. The computer program product according to claim 27, wherein the computer readable program when executed on a computer causes the computer to generate the file related request tag in response to a size of the file.

30. The computer program product according to claim 27, wherein the computer readable program when executed on a computer causes the computer to: receive a file related request that is a request to store the file at the network cache; store the file at the selected storage unit if the file is not stored in the network cache and update metadata stored in the selected control unit.

31. A computer program product comprising a computer usable medium including a computer readable program, wherein the computer readable program when executed on a computer causes the computer to: generate a file tag responsive to a content of a file to be associated with a file related request; send to a network cache a file related request that comprises the file tag; and assist in a display of virtual directory of files that were requested to be stored at the network cache by a user of the computer.

32. The computer program product according to claim 31, wherein the computer readable program when executed on a computer causes the computer to generate the file tag by applying a hash function on a content of the file and on a size of the file.

33. The computer program product according to claim 31, wherein the computer readable program when executed on a computer causes the computer to: send a file related request that comprises the file tag to a control unit; receive a response indicative of a selected control unit associated with a user device that comprises the computer; send the file related request to the selected control unit; receive a file related request tag and a selected storage unit identifier from the selected control unit; send a file related request that comprises the file related request tag to the selected storage unit; and receive the response to the file related request from the selected storage unit.

34. The computer program product according to claim 31, wherein the computer readable program when executed on a computer causes the computer to: send a file related request to a selected control unit associated with a user device that comprises the computer; receive a file related request tag and a selected storage unit identifier from the selected control unit; send a file related request that comprises the file related request tag to the selected storage unit; and receive a response to the file related request from the selected storage unit.

35. A device, the device comprises: a processor, adapted to generate a file tag responsive to a content of a file to be associated with a file related request; and assist in a display of virtual directory of files that were requested to be stored at the network cache by a user of the computer; and a communication module adapted to send to a network cache a file related request that comprises the file tag.

36. The device according to claim 35 wherein the processor is adapted to generate the file tag by applying a hash function on a content of the file and on a size of the file.

37. The device according to claim 35, further adapted to send a file related request that comprises the file tag to a non-selected control unit; receive a response indicative of a selected control unit associated with a user device; send the file related request to the selected control unit; receive a file related request tag and a selected storage unit identifier from the selected control unit; send a file related request that comprises the file related request tag to the selected storage unit; and receive the response to the file related request from the selected storage unit.

38. The device according to claim 35, further adapted to: send a file related request to a selected control unit associated with a user device that comprises the computer; receive a file related request tag and a selected storage unit identifier from the selected control unit; send a file related request that comprises the file related request tag to the selected storage unit; and receive a response to the file related request from the selected storage unit.

39. A method, comprising: generating a file tag responsive to a content of a file to be associated with a file related request; sending to a network cache a file related request that comprises the file tag; and assisting in a display of virtual directory of files that were requested to be stored at the network cache by a user of the computer.

40. The method according to claim 39 wherein the generating the file tag comprises generating the file tag by applying a hash function on a content of the file and on a size of the file.

41. The method according to claim 39, further comprising: sending a file related request that comprises the file tag to a non-selected control unit; receiving a response indicative of a selected control unit associated with a user device; sending the file related request to the selected control unit; receiving a file related request tag and a selected storage unit identifier from the selected control unit; and sending a file related request that comprises the file related request tag to the selected storage unit; and receiving the response to the file related request from the selected storage unit.

42. The method according to claim 39, further comprising: sending a file related request to a selected control unit associated with a user device that comprises the computer; receiving a file related request tag and a selected storage unit identifier from the selected control unit; sending a file related request that comprises the file related request tag to the selected storage unit; and receiving a response to the file related request from the selected storage unit.
